(19) United States
(12) Patent Application Publication
(10) Pub. No.: US 2010/0252488 A1
(43) Pub. Date: Oct. 7, 2010

(54) METHOD AND INSTALLATION FOR SORTING FLAT ARTICLES

(75) Inventors: Zsolt Balogh, Weingarten (DE); Armin Zimmermann, Konstanz (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/754,771

(22) Filed: Apr. 6, 2010

(30) Foreign Application Priority Data
Apr. 6, 2009 (DE) 10 2009 016 559.2

(51) Int. Cl. B07C 5/00

(52) U.S. Cl. 209/509

(57) ABSTRACT

A method and an installation for sorting flat articles, in particular flat items of mail, discharges each article to be sorted, in dependence on a respectively measured feature value, into an output device. A resulting stack is moved onto a transporting configuration with planes of the articles of the stack perpendicular to a first transporting direction. The transporting configuration transports the stack toward a processing device. The transporting configuration transports the stack initially in the first transporting direction. Following transportation in the first transporting direction, the transporting configuration rotates the stack around a curve from the first transporting direction into a second transporting direction. The transporting configuration then transports the stack toward the processing device in the second transporting direction.

### CROSS-REFERENCE TO RELATED APPLICATION

This application claims the priority, under 35 U.S.C. §119, of German Patent Application DE 10 2009 016 559.2, filed Apr. 6, 2009; the prior application is herewith incorporated by reference in its entirety.

### BACKGROUND OF THE INVENTION

### Field of the Invention

The invention relates to a method and an installation for sorting flat articles, in particular flat items of mail.

European Patent EP 0 634 957 B1, corresponding to U.S. Pat. No. 5,421,464, discloses method for sorting flat articles each extending over an article plane. The method includes providing a sorting installation having a processing device and a plurality of output devices, measuring, with the sorting installation, a value assumed by a predetermined feature for each article to be sorted, and discharging each article, with the sorting installation, in dependence on the respectively measured feature value, into an output device of the sorting installation, to create a stack of flat articles in at least one output device having been discharged into that output device, moving at least one stack onto a transporting configuration to cause the planes of the articles of the stack to be located perpendicularly to a first transporting direction, transporting the stack, with the transporting configuration, toward a processing device, transporting the stack, with the transporting configuration, toward the processing device initially in the first transporting direction and then in a second transporting direction, and processing the stack with the processing device.

European Patent EP 0 634 957 B1, corresponding to U.S. Pat. No. 5,421,464, also discloses a sorting installation for sorting flat articles each extending over an article plane. The sorting installation includes a measuring device, a discharging device, a transporting configuration having a first transporting device and a second transporting device, a plurality of output devices, and a processing device. The measuring device is configured to measure a value assumed by a predetermined feature for each article to be sorted. The discharging device is configured to discharge each article, in dependence on the respectively measured feature value, into one of the output devices to create a stack of flat articles, in at least one of the output devices, having been discharged into the at least one output device. The first transporting device is configured to move a stack of flat articles out of one of the output devices onto the first transporting device with all of the planes of the articles of the stack located perpendicularly to a first transporting direction, and the first transporting device is configured to transport a stack toward the processing device in the first transporting direction, with the planes of the articles of the stack located perpendicularly to the first transporting direction. The second transporting device is configured to transport the stack toward the processing device in a second transporting direction, and the processing device is configured to process the stack.

European Patent EP 0 634 957 B1, corresponding to U.S. Pat. No. 5,421,464, describes a method of sorting flat items of mail and a sorting installation. The items of mail which are to be sorted are sorted in a number of successive sorting sequences (sequencing). The sorting installation used for that purpose has an input module 5 with a separator, a discharging device and at least one row 1 of output devices (stacking compartments a, b, c, etc.). A feeding conveying belt 2 is disposed in relation to the row 1 in such a way that the row 1 and the feeding conveying belt 2 form two legs of a U.

The separator of the sorting installation of European Patent EP 0 634 957 B1, corresponding to U.S. Pat. No. 5,421,464, separates the items of mail and generates a stream of spaced-apart items of mail. The discharging device divides those items of mail between the output devices a, b, c, etc., and therefore a respective stack of upright flat items of mail is formed in each output device. A respective stack of items of mail is removed from an output device a, b, c, etc. and moved onto the feeding conveying belt for a subsequent sorting sequence. In one configuration, a transfer bridge 6 is used for that purpose. During transfer from the output device onto the feeding conveying belt, the stack is removed from the output device, in the first instance, by a linear movement, then is rotated through 90° away from the separator and then is transported linearly toward the separator. The items of mail of the stack then run through the sorting installation again.

U.S. Pat. No. 5,857,830 describes an article handling system 10 with a discharging device (sorter 15), and also describes a configuration (array 19) with a number of rows of output devices (output compartment 20) located one above the other. A container (cartridge switch) with flat articles can be moved into each output device. A handling machine (XY cartridge transfer and handling robot 30) has a bearing surface 35 for containers and is able to displace containers vertically and horizontally. Containers can also be stored on an interim basis in an interim storage device (buffer shell 40). The handling machine 30 is able to transfer containers back and forth between the configuration 19 and the interim storage device 40 and is located between the configuration 19 and the interim storage device 40. The sorting installation also has a feeding device (auto feeder 50) with a separator (feeding station 70). The handling machine 30 is able to move filled containers towards feeding devices 50, optionally from an output device 20 of the configuration 19 or from the interim storage device 40, and to rotate the container through 90° in the process.

U.S. Pat. No. 7,467,792 B2 describes a sorting installation with a plurality of conveying belts. Such a conveying belt transports a container, which is filled with items of mail, in a first transporting direction, around a curve and in a second transporting direction, as is seen in FIGS. 10a to 10d.

### SUMMARY OF THE INVENTION

It is accordingly an object of the invention to provide a method and an installation for sorting flat articles, which overcome the hereinafore-mentioned disadvantages of the heretofore-known methods and installations of this general type and which avoid the need for a processing device to be disposed in such a way that a transporting configuration transports a stack to the processing device by way of a linear movement in a first transporting direction.

With the foregoing and other objects in view there is provided, in accordance with the invention, a method for sorting flat articles each extending over an article plane. The method comprises providing a sorting installation having a processing device and a plurality of output devices, measuring, with the sorting installation, a value assumed by a predetermined feature for each article to be sorted, and discharging each article, with the sorting installation, in dependence on the respectively measured feature value, into an output device of the sorting installation, to create a stack of flat articles in at least one output device having been discharged into that output device, moving at least one stack onto a transporting configuration to cause the planes of the articles of the stack to be located perpendicularly to a first transporting direction, transporting the stack, with the transporting configuration, toward a processing device, transporting the stack, with the transporting configuration, toward the processing device initially in the first transporting direction and then in a second transporting direction, processing the stack with the processing device, providing a curved transporting device of the transporting configuration, and rotating the stack, with the curved transporting device, following transportation in the first transporting direction, around a curve from the first transporting direction into the second transporting direction, causing the stack to fan out upon rotation through the curve.

With the objects of the invention in view, there is also provided a sorting installation for sorting flat articles each extending over an article plane. The sorting installation comprises a measuring device, a discharging device, a transporting configuration having a first transporting device, a second transporting device and a curved transporting device, a plurality of output devices, and a processing device. The measuring device is configured to measure a value assumed by a predetermined feature for each article to be sorted. The discharging device is configured to discharge each article, in dependence on the respectively measured feature value, into one of the output devices to create a stack of flat articles, in at least one of the output devices, having been discharged into the at least one output device. The first transporting device is configured to move a stack of flat articles out of one of the output devices onto the first transporting device with all of the planes of the articles of the stack located perpendicularly to a first transporting direction, and the first transporting device is configured to transport a stack toward the processing device in the first transporting direction, with the planes of the articles of the stack located perpendicularly to the first transporting direction. The second transporting device is configured to transport the stack toward the processing device in a second transporting direction. The processing device is configured to process the stack and the curved transporting device is configured to rotate a stack around a curve from the first transporting direction into the second transporting direction to cause the stack to fan out upon rotation through the curve.

As mentioned above, the invention specifies a method and an installation for sorting flat articles. Each flat article which is to be sorted extends over an article plane.

The sorting installation according to the invention includes a processing device and a plurality of output devices. The method according to the invention is implemented by using such a sorting installation, having a processing device and output devices.

A measurable feature is predetermined. The sorting installation measures, for each article which is to be sorted, the value assumed by the predetermined feature for this article.

The sorting installation discharges each article which is to be sorted, in dependence on the respectively measured feature value, into an output device of the sorting installation. This creates, in at least one output device, a stack of flat articles which have been discharged into this output device.

The at least one stack is moved onto a transporting configuration in such a way that the planes of the articles of the stack are located perpendicularly to a first transporting direction.

The transporting configuration transports the stack toward a processing device. The transporting configuration in this case transports the stack in the first instance in the first transporting direction. Following transportation in the first transporting direction, the transporting configuration rotates the stack around a curve from the first transporting direction into a second transporting direction. The transporting configuration then transports the stack toward the processing device in the second transporting direction.

The method according to the invention and the apparatus according to the invention do away with the need to rotate the at least one stack, e.g. manually or through the use of a handling machine, once the stack has been moved onto the transporting configuration. Rather, the transporting configuration rotates the stack automatically in the respectively desired direction.

The invention makes it possible to transport the stack from the output device toward the processing device around the sorting installation. The processing device can thus be positioned in a manner which is expedient for further processing.

The transporting path over which the stack is transported can be made up of a straight section of freely selectable length, of a curved segment with a freely selectable radius and angle of curvature and of a very straight section of freely selectable length. It is possible to add further curved segments and straight sections. This makes it possible for the processing device to be placed in any desired position relative to the output device, even when the positions of further constituent parts of the sorting installation around which the stack has to be transported are already fixed.

The processing device is preferably configured as a separator. The method according to the invention and the installation according to the invention can be used in order to sort articles in two sorting sequences. In the first sorting sequence, the sorting installation discharges the articles into the output device and divides them up between the output devices. In the process, a stack is formed in at least one output device. This stack is moved onto the transporting configuration. The transporting configuration transports the stack to the separator. This separator separators the articles, and the separated articles run through the sorting installation again, this time in a second sorting sequence.

The curved transporting device may include a turntable which rotates about a vertical axis of rotation. This configuration allows a mechanically straightforward construction of the curved transporting device without a conveying belt or any other elastic parts which may render ongoing maintenance necessary. It is possible for this turntable to be constructed in one piece (in an integrally formed manner) or to be made up of lamellae.

The curved transporting device may also include an endless conveying belt which is guided around the curve. This configuration saves space in relation to a turntable because the conveying belts need only cover the angle of curvature which is actually required rather than a full circle of 360 degrees.

Other features which are considered as characteristic for the invention are set forth in the appended claims.

Although the invention is illustrated and described herein as embodied in a method and an installation for sorting flat articles, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, top-plan view of a sorting installation of an exemplary embodiment of the invention;

FIG. 2 is a top-plan view of four output devices and a transporting configuration of the sorting installation of FIG. 1, with a stack in one output device;

FIG. 3 is a fragmentary, top-plan view of a configuration of a curved transporting device of FIG. 1 with two rails;

FIG. 4 is a top-plan view of a configuration of the curved transporting device of FIG. 1 with an endless conveying belt which is produced from a circular ring;

FIG. 5 is a fragmentary, side-elevational view of a turntable and two endless conveying belts; and

FIG. 6 is a fragmentary, cross-sectional view of two output devices without side walls.

### DETAILED DESCRIPTION OF THE INVENTION

In the exemplary embodiment, the sorting installation is used in order to sort flat items of mail, in particular standard letters, large letters, postcards and/or catalogs. Each item of mail extends over an article plane and has a front side and a rear side. One side of each item of mail bears information relating to a delivery address to which the item of mail has to be transported. This information is in a form which can be read by a person or is in the form of a bar code or of a matrix code or of some other coding.

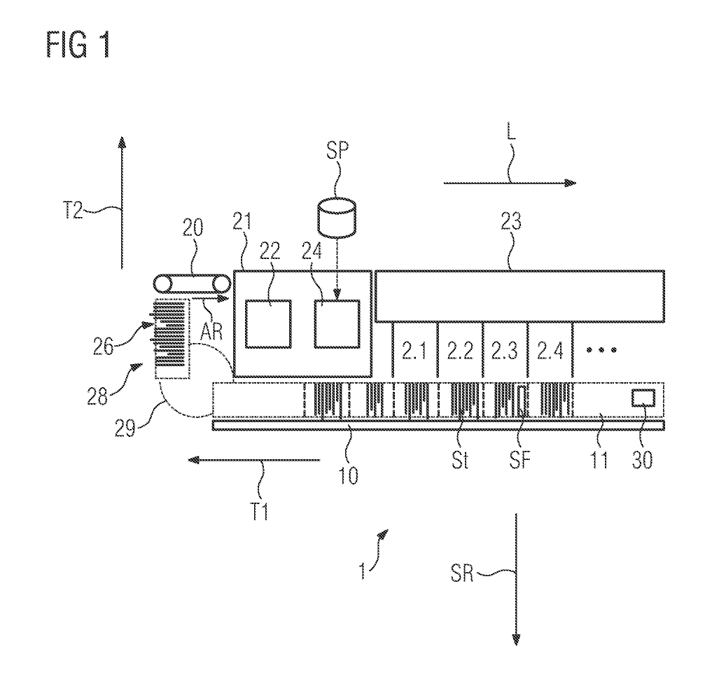

Referring now to the figures of the drawings in detail and first, particularly, to FIG. 1 thereof, there is seen a diagrammatic, top-plan view of a sorting installation of an exemplary embodiment of the invention. This sorting installation includes the following constituent parts:
a feeding device (feeder) with a separator (singulator) 20,
a transporting device 21,
a reader 22,
a discharging device 23,
a configuration having a multiplicity of output device 2.1, 2.2, etc.,
a first transporting device 1,
a second transporting device 28,
a curved transporting device 29,
a positioning device 30, and
a machine controller 24.

The first transporting device 1, the second transporting device 28 and the curved transporting device 29 together form a transporting configuration.

In the exemplary embodiment, an endless conveying belt 26 belongs both to the feeding device and to the second transporting device 28. The conveying belt 26 transports stacks of items of mail in a second transporting direction T2.

A stack of items of mail, which are to be sorted, is fed to the feeding device. The items of mail stand upright during the feeding operation. The conveying belt 26 of the feeding device transports the items of mail to the separator 20. This separator 20 separates the stack of the items of mail by successively withdrawing a respective item of mail from the stack in a withdrawal direction AR. The separator 20 thus creates a series of upright items of mail which are spaced apart from one another.

The transporting device 21 transports the sequence of spaced-apart, upright items of mail through the sorting installation. The transporting device 21 preferably includes a system of a plurality of vertically disposed endless conveying belts, of which two clamp an item of mail temporarily between them in each case. It is possible for an item of mail to be turned by the conveying belts of the transporting device 21, e.g. in order for it to be possible to read the delivery address.

During transportation, the items of mail pass the reader 22. The reader 22 generates a respective digital image of that side of an item of mail on which the information relating to the delivery address can be found. The reader 22 evaluates this image and attempts, in a first instance, to decode the delivery address automatically, e.g. by Optical Character Recognition (OCR) or by bar code reading. If this is unsuccessful, then the image is displayed on a screen of a video coding station. An operator reads the delivery address and enters it into a keyboard or the like.

The machine controller 24 evaluates a computer-available sorting plan SP which is stored in a data memory. This sorting plan SP assigns a respective output device 2.1, 2.2, etc. to each possible delivery address of an item of mail. The sorting plan SP thus establishes which items of mail with which delivery addresses should be discharged into which output device.

In the exemplary embodiment, there are considerably more possible delivery addresses than output devices, and therefore the sorting plan SP usually assigns a number of delivery addresses to one output device 2.1, 2.2, etc. It is possible for the sorting plan SP to reserve individual output device for just a single delivery address in each case because a large number of items of mail are directed to this delivery address.

The transporting device 21 transports the items of mail further to the discharging device 23. This discharging device 23 preferably includes a series of diverters, namely in each case at least one diverter per output device 2.1, 2.2, etc. In each diverter, a discharging path branches off from the transporting path to the associated output device. A respective discharging path connects the transporting path to the output device. The diverter is activated by the machine controller 24 and optionally deflects an item of mail into the discharging path or leaves the item of mail in the transporting path.

The actual transporting speed of each transporting path is measured. The machine controller 24 thus “knows” at which point in time each item of mail is located at which location in the transporting device 21. Moreover, the machine controller 24 “knows” the respective delivery address of each item of mail once the reader 22 has decoded the delivery address. The machine controller 24 activates that diverter which connects the transporting path to that discharging path which leads to that output device 2.1, 2.2, etc. into which the item of mail is to be discharged in accordance with the read delivery address and the sorting plan SP. The item of mail is discharged from the transporting path through the use of the diverter and is transported on the discharging path to the output device and stacked there.

The multiplicity of output devices 2.1, 2.2, etc. of the configuration are disposed one behind the other, as seen in a longitudinal direction L. In the exemplary embodiment, the longitudinal direction L is oriented away from the feeding device with the separator 20. It is possible for the output device 2.1, etc. to be provided in a number of rows and for the rows to be disposed vertically or obliquely one above the other. Each row extends along the longitudinal direction L.

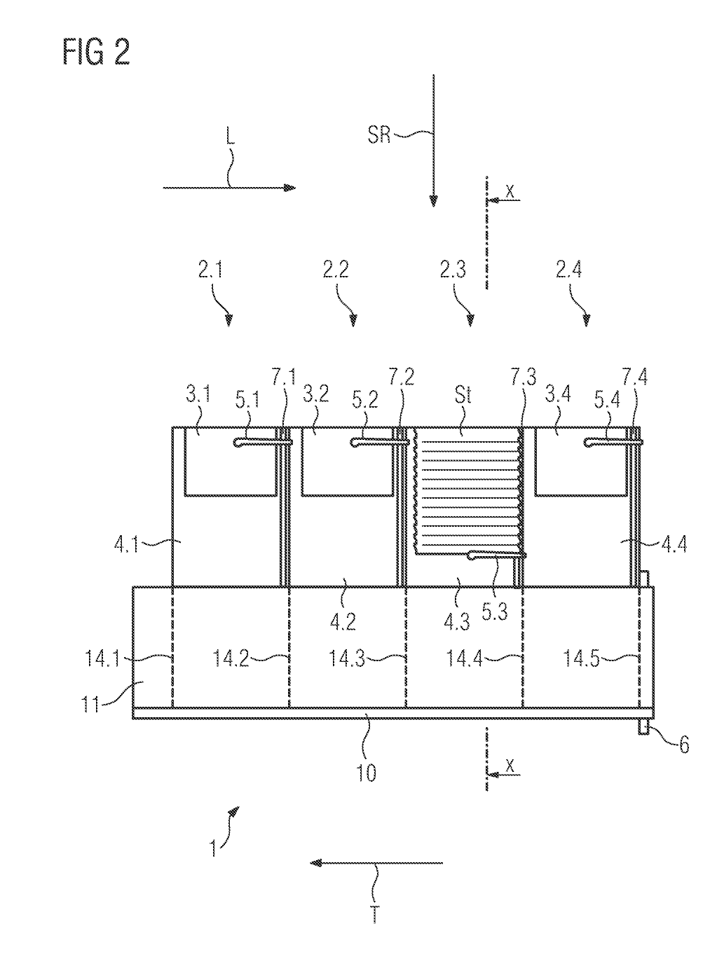

FIG. 2 shows four output devices 2.1, 2.2, 2.3 and 2.4 and the first transporting device 1 from the discussion above. It is also the case that the first transporting device 1 extends along the longitudinal direction L. In addition, a stack St is shown in the output device 2.3.

The items of mail stand on a conveying belt 11 of the first transporting device 1 while the conveying belt 11 transports the transversely located stack or stacks. The first transporting device 1 transports each stack in a first transporting direction T1. In the exemplary embodiment, this first transporting direction T1 runs counter to the longitudinal direction L. A stacking direction SR is located perpendicularly to the first transporting direction T1.

In one configuration, the items of mail are guided by a lateral guide device 10 during transportation in the first transporting direction T1. The endless conveying belt 11 is located between this guide device 10 and the rows of output devices 2.1, 2.2, etc. The guide device 10 is, for example, in the form of a guard rail.

In another configuration, there is no guide device 10 provided, and it is therefore possible for a transported stack to include items of mail of any desired width.

In one configuration, the stack is supported, and pushed, by a respective supporting device. This supporting device is positioned behind the stack, as seen in the transporting directions T1 and T2. A respective supporting surface of the supporting device extends in a supporting plane parallel to the article planes and perpendicularly to the stacking direction SR. A connecting member connects the supporting surface to a guide device. The connecting member and thus also the supporting surface SF, are displaced in the transporting directions and around a curve and push the stack in front of them. FIG. 1 shows, by way of example, a supporting surface SF behind the stack ST from the output device 2.3.

The curved transporting device 29 transfers each stack automatically from the first transporting device 1 onto the second transporting device 28.

The transition from the first transporting device 1 to the curved transporting device 29 preferably forms a step, through which a transported stack slides downward. The vertical extent of the step is significantly smaller than the height of each item of mail, e.g. 20 mm to 30 mm. Such a step is preferably also incorporated between the curved transporting device 29 and the second transporting device 28.

For example, the first transporting device includes an endless conveying belt 11 which has a small vertical dimension because it is guided around a thin roller. This roller and one end of the endless conveying belt 11 are located above the curved transporting device 29. This end of the endless conveying belt 11 forms the step.

While the curved transporting device 29 transports a stack through the curve, the stack fans out. The distance between two items of mail of the stack is greater on the outside of the curve than on the inside. The curved transporting device 29 transports at a predetermined maximum speed in order to ensure that the centrifugal force does not destroy the stack. The radius is greater than or equal to a minimum radius.

It is possible for both the first transporting device 1 and the curved transporting device 29 to each include an endless conveying belt. These two conveying belts are provided on the same level. A slit is located between them. The conveying belts are narrower than the items of mail, and therefore the items of mail project beyond the conveying belt at least on one side. At least one supporting unit alongside the conveying belts bears the items of mail in addition and prevents an item of mail from falling through the slit between the two conveying belts.

The following items of mail push an item of mail over the slit from the first transporting device 1 onto the curved transporting device 29. It is also possible for the transition between the curved transporting device 29 and the second transporting device 28 to be configured in this way. The support is preferably in the form of two rails S1, S2, between which the conveying belts 11, 31, 26 run.

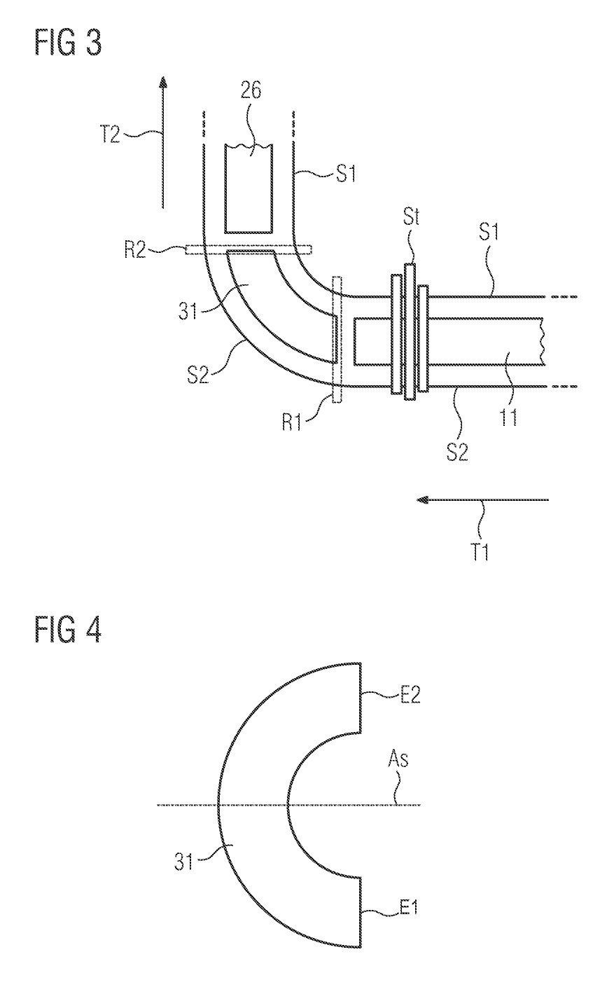

FIG. 3 shows this configuration with a supporting device in the form of two rails S1, S2. The figure illustrates two rails S1 and S2, on which the items of mail are transported first of all in the first transporting direction T1, then through the curve and then in the second transporting direction T2. The figure also illustrates the endless conveying belt 11 of the first transporting device 1, an endless conveying belt 31 of the curved transporting device 29 and the endless conveying belt 26 of the second transporting device 28. The endless conveying belt 31 of the curved transporting device 29 is guided around two rollers R1, R2. One roller, preferably the downstream roller R2, is driven, the other roller is not. The rails S1, S2 run through the curve.

In one configuration, the curved transporting device 29 includes an endless conveying belt 31. This conveying belt is produced from a segment of a circle or of a circular ring (torus). FIG. 4 shows, by way of example, a segment of such a circular ring. In order to ensure that the curved transporting device 29 is able to convey a stack through a curve of α [degrees], use is made of a segment with an angle of at least 2*α. In the example of FIG. 4, α is 90 degrees. This circular ring is folded about an axis As, and the two sections are connected to one another at straight ends E1, E2 of the circular ring. This creates an endless conveying belt 31.

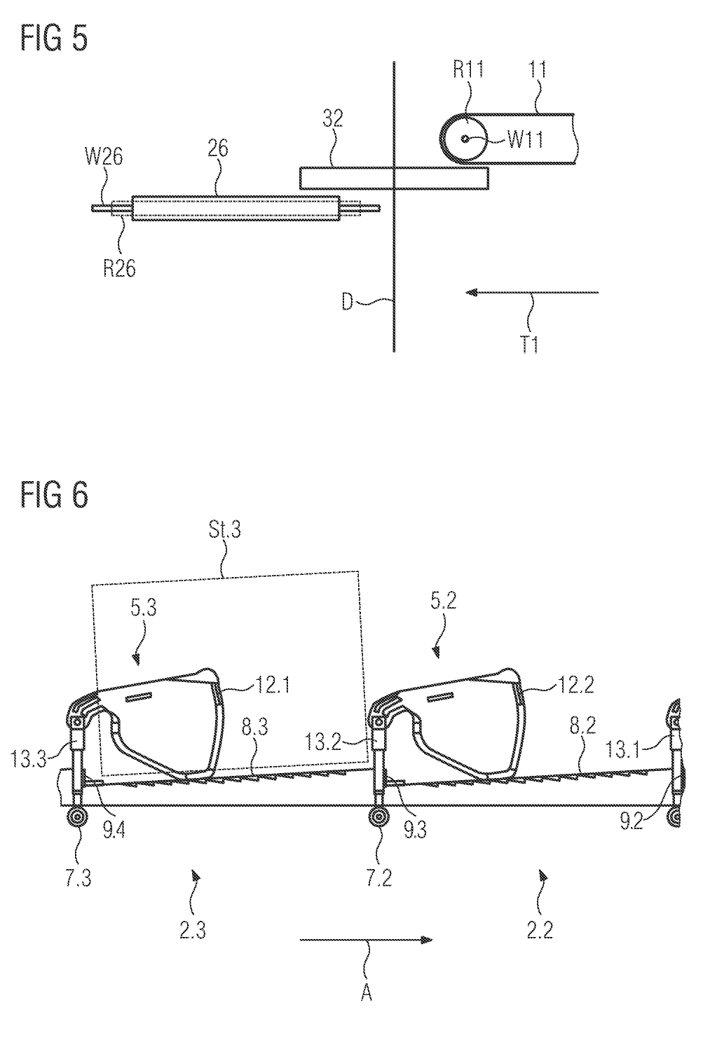

In another configuration, which FIG. 5 shows, the curved transporting device 29 includes a horizontal turntable 32 which is mounted rotatably about a vertical axis of rotation D and is rotated about this axis. The stack stands on this turntable 32 while the rotating turntable 32 transports the stack through the curve. It is also the case in this configuration that the items of mail are transported over two steps, stages or intervals. There is one step between the first transporting device 1 and the turntable 32, and a further step between the turntable 32 and the second transporting device 28. FIG. 5 shows a configuration in which the first transporting device 1 has an endless conveying belt 11 and the second transporting device 28 has an endless conveying belt 26. The second transporting direction T2 is located perpendicularly to the plane of the drawing in FIG. 5.

The conveying belt 11 is guided around a roller R11. The roller R11 is seated on a driven shaft W11. The shaft W11 rotates, and rotates the roller R11 along with it. This makes the conveying belt 11 rotate. Accordingly, the conveying belt 26 is guided around a roller R26, and the roller 26 is seated on a shaft W26.

In the embodiment which FIGS. 1 and 3 show, the curve is 90 degrees, i.e. there is an angle of 90 degrees between the first transporting direction T1 and the second transporting direction T2. It is also possible for the curve to have some other angle of curvature.

The endless conveying belt 26 of the second transporting device 28 transports each stack in a second transporting direction T2. In the exemplary embodiment, the second transporting direction T2 is located perpendicularly to the first transporting direction T1. Generally, the angle between the two transporting directions T1 and T2 is equal to the angle of curvature a of the curved transporting device 29. The direction SR of each stack runs parallel to the second transporting direction T2 while the second transporting device 28 transports the stack in the second transporting direction T2.

The endless conveying belt 26 of the second transporting device 28 transports each stack to the separator 20 in the second transporting direction T2. Throughout transportation from the respective output device to the separator 20, the stack is not rotated relative to the transporting configuration 1, 28, 29. Rather, the stacking direction SR remains unchanged relative to the transporting configuration 1, 28, 29, and thus changes only in the curved transporting device 29 together with the transporting direction.

It is also possible for the second transporting device 28 to transport the stack St not to a separator 20, but to some other processing device, e.g. to a stack storage device in which the stacks are stored on a temporary basis.

Each output device 2.1, 2.2, etc. includes a base. In one embodiment, two adjacent output device 2.1, 2.2, etc. are separated from one another by a respective side wall.

In another embodiment, the bases of the output devices 2.1, 2.2, etc. are inclined in relation to the horizontal, and there is an edge between two adjacent output devices.

In a preferred development of this embodiment, the base of each output device 2.1, 2.2, etc. has a region in which the surface is covered with imbricated scales. The scales are disposed in such a way that they make it more difficult for a stack St of flat items of mail to be displaced in the longitudinal direction L or counter to the longitudinal direction L. The example of FIG. 2 shows four regions 3.1, 3.2, 3.3 and 3.4 with scale-covered surfaces. These regions 3.1, 3.2, etc. belong to the bases of the output device 2.1, 2.2, etc.

It can be seen in the figures that each base, as seen in the stacking direction SR, in the first instance has a respective scale-covered region 3.1, 3.2, 3.3 and 3.4, which is adjoined in each case by a non-scaled region 4.1, 4.2, 4.3, 4.4. A non-scaled region 4.1, 4.2, 4.3, 4.4 is thus located between the scale-covered region 3.1, 3.2, 3.3, 3.4 and the first transporting device 1 with the conveying belt 11.

As a result of this configuration, the scales make it difficult for an item of mail to be displaced while the item of mail is being discharged. In contrast, once the item of mail has come into contact with the stack St, even the friction between the items of mail of the stack St makes it more difficult for an individual item of mail to be displaced, and therefore the surface of the base beneath the stack need no longer be covered with scales.

As already explained, a number of flat items of mail are usually discharged into the same output device, that is to say all of the items of mail with delivery addresses which the sorting plan SP assigns to this output device. Those flat items of mail which have been discharged into this output device 2.3 form a stack St. The direction SR of this stack St is located perpendicularly to the planes of the items of mail and, in the exemplary embodiment, also perpendicularly to the longitudinal direction L.

In the example of FIG. 2, a number of items of mail are discharged into the output device 2.3 and form a stack St there.

Each output device 2.1, 2.2, etc., moreover, has a respective output-device-supporting component. This supporting component includes a supporting surface, a connecting member and a guide rail. The support surface and the connecting member, together, are in the form of a paddle. The guide rail runs parallel to the stacking direction SR. The connecting member is fixed to the supporting surface and is able to slide back and forth in the guide rail.

In FIG. 2, four paddles 5.1, 5.2, 5.3 and 5.4 of the four output devices 2.1, 2.2, 2.3 and 2.4 can be seen from above, as can four guide rails 7.1, 7.2, 7.3 and 7.4. The stack St of items of mail in the output device 2.3 has displaced the paddle 5.3 toward the first transporting device 1.

The output-device-supporting component 5.1, 5.2, etc. prevents tipping over of the stack of items of mail in the output device. The items of mail are discharged into the output device, in the stacking direction SR, against the paddle. The growing stack St displaces the paddle, in the stacking direction SR, away from the diverter and thus, perpendicularly to the longitudinal direction L, toward the first transporting device 1. In the example of FIG. 2, the paddle 5.3 is displaced by the stack St in the output device 2.3.

The connecting member is connected to a restoring component, preferably to a spring. The growing stack St displaces the paddle 5.3 counter to the force of the restoring component. The paddle 5.3 thus pushes the stack St toward the diverter again, counter to the stacking direction SR. This prevents the stack St from falling over.

In the exemplary embodiment, the first transporting device 1 with the conveying belt 11 is adjacent the row or the rows of output devices 2.1, 2.2, etc. in such a way that the distance between the output devices 2.1, 2.2, etc. and the first transporting device 1 is small, e.g. less than 10 cm. The distance is small enough for it to be possible for a stack of items of mail to be transferred easily from the row of output devices onto the first transporting device 1.

It is also possible for the distance between the output devices 2.1, 2.2, etc. and the first transporting device 1 to be significantly greater. For example, a transfer bridge may transfer the stack. Such a transfer bridge is described, for example, in European Patent EP 0 634 957 B1, corresponding to U.S. Pat. No. 5,421,464, and in German Patent DE 42 36 507 C1, corresponding to U.S. Pat. No. 5,353,903.

FIG. 6 shows the two output devices 2.1 and 2.2 in cross section. The conveying belt 11 of the first transporting device 1 is located behind the two output devices 2.2 and 2.3, as seen in the viewing direction of FIG. 6. The scales on the bases of the two output devices 2.2 and 2.3, inter alia two sets of scales 8.2 and 8.3, are illustrated. Also evident is an edge 9.2 between the adjacent output devices 2.1 and 2.2 and an edge 9.3 between the adjacent output device 2.2 and 2.3.

The aforementioned supporting component 5.3 in the form of a paddle is moved toward the discharging device, counter to the stacking direction SR, by a restoring component. The supporting component 5.3 thus supports a stack St in the output device 2.3. The stack St is located in front of the supporting component 5.3 of the output device 2.3, as seen in the viewing direction of FIG. 6.

The stacking direction SR is located perpendicularly to the plane of the drawing in FIG. 6, and the stack St pushes the supporting component 5.3 toward the conveying belt 11 and away from anyone viewing FIG. 6.

In the embodiment which is shown in FIG. 6, the base of each output device forms a planar surface which is covered with scales in one region. In a development of this configuration, the base of each output surface is subdivided into two regions which are located one behind the other as seen in the direction of ascent A, that is to say one beside the other as seen in the stacking direction SR: a relatively steep region and a shallower region. The edge between the output device and the adjacent output device is adjoined, as seen in the direction of ascent A, in the first instance by a region which is inclined to a relatively pronounced extent in relation to the horizontal and then by a region which is inclined to a less pronounced extent or is even horizontal.

1. A method for sorting flat articles each extending over an article plane, the method comprising the following steps:
providing a sorting installation having a processing device and a plurality of output devices;
measuring, with the sorting installation, a value assumed by a predetermined feature for each article to be sorted, and discharging each article, with the sorting installation, in dependence on the respectively measured feature value, into an output device of the sorting installation, to create a stack of flat articles in at least one output device having been discharged into that output device;
moving at least one stack onto a transporting configuration to cause the planes of the articles of the stack to be located perpendicularly to a first transporting direction;
transporting the stack, with the transporting configuration, toward a processing device;
transporting the stack, with the transporting configuration, toward the processing device initially in the first transporting direction and then in a second transporting direction;
processing the stack with the processing device;
providing a curved transporting device of the transporting configuration; and
rotating the stack, with the curved transporting device, following transportation in the first transporting direction, around a curve from the first transporting direction into the second transporting direction, causing the stack to fan out upon rotation through the curve.

2. The method according to claim 1, which further comprises:
carrying out the step of transporting the at least one stack by transporting a supporting device with a supporting surface, extending in a supporting plane, together with the stack, in the first transporting direction, through the curve and in the second transporting direction;
placing the supporting surface parallel to the article planes; and
placing the supporting surface behind the transported stack, in the transporting directions.

3. The method according to claim 1, which further comprises transporting the stack, with the transporting configuration, over a step between transporting the stack in the first transporting direction and transporting the stack around the curve.

4. The method according to claim 1, which further comprises:
providing the processing device as a separator;
withdrawing a respective article from the fed stack, with the separator, in a withdrawal direction perpendicular to the second transporting direction; and
discharging the separated articles again into the output devices of the sorting installation.

5. A sorting installation for sorting flat articles each extending over an article plane, the sorting installation comprising:
a measuring device;
a discharging device;
a transporting configuration having a first transporting device, a second transporting device and a curved transporting device;
a plurality of output devices; and
a processing device;
said measuring device being configured to measure a value assumed by a predetermined feature for each article to be sorted;
said discharging device being configured to discharge each article, in dependence on the respectively measured feature value, into one of said output devices to create a stack of flat articles, in at least one of said output devices, having been discharged into said at least one output device;
said first transporting device being configured to move a stack of flat articles out of one of said output devices onto said first transporting device with all of the planes of the articles of the stack located perpendicularly to a first transporting direction, and said first transporting device being configured to transport a stack toward said processing device in the first transporting direction, with the planes of the articles of the stack located perpendicularly to the first transporting direction;
said second transporting device being configured to transport the stack toward said processing device in a second transporting direction;
said processing device being configured to process the stack; and
said curved transporting device being configured to rotate a stack around a curve from the first transporting direction into the second transporting direction to cause the stack to fan out upon rotation through said curve.

6. The installation according to claim 5, wherein said curved transporting device includes an underfloor turntable.

7. The installation according to claim 5, wherein said curved transporting device includes a plurality of underfloor conveying belts disposed one behind the other over a circle segment.

8. The installation according to claim 7, wherein said underfloor conveying belts of said curved transporting device overlap one another partially.

9. The installation according to claim 5, wherein said curved transporting device includes an endless conveying belt formed from a segment of a circle or circular ring and having straight ends joined together.

10. The installation according to claim 5, which further comprises:
a supporting device;
said first transporting device and said curved transporting device each including a respective endless conveying belt; and
said two endless conveying belts and said supporting device being configured to cause each transported article, during its transport in the first transporting direction and around said curve, to always be borne by one of said two endless conveying belts or by said supporting device or by both.

11. The installation according to claim 10, wherein said supporting device includes two rails between which said two endless conveying belts run.

12. The installation according to claim 5, which further comprises:
a supporting device;
said curved transporting device and said second transporting device each including a respective endless conveying belt; and
said two endless conveying belts and said supporting device being configured to cause each transported article, during its transport in the first transporting direction and around said curve, to always be borne by one of said two endless conveying belts or by said supporting device or by both.

13. The installation according to claim 5, wherein:
said first transporting device and said curved transporting device overlap one another partially and form a step; and
said transporting configuration is configured to transport a stack over said step from said first transporting device to said curved transporting device.

14. The installation according to claim 5, wherein:
said curved transporting device and said second transporting device overlap one another partially and form a step; and
said transporting configuration is configured to transport a stack over said step from said curved transporting device to said second transporting device.

15. The installation according to claim 5, wherein:
said processing device is configured as a separator;
said separator is configured to withdraw a respective article from the fed stack in a withdrawal direction perpendicularly to the second transporting direction; and
said sorting installation is configured to discharge articles again into said output devices of the sorting installation.
